(19) United States
(12) Patent Application Publication
(10) Pub. No.: US 2016/0240165 A1
(43) Pub. Date: Aug. 18, 2016

(54) DISPLAY CONTROLLER OF INFORMATION TERMINAL AND DISPLAY CONTROL METHOD OF INFORMATION TERMINAL

(71) Applicant: TOYOTA JIDOSHA KABUSHIKI KAISHA, Toyota-shi, Aichi-ken (JP)

(72) Inventor: Shinichi SUZUKI, Setagaya-ku, Tokyo (JP)

(73) Assignee: TOYOTA JIDOSHA KABUSHIKI KAISHA, Toyota-shi, Aichi-ken (JP)

(21) Appl. No.: 15/025,666

(22) PCT Filed: Oct. 3, 2014
(86) PCT No.: PCT/IB2014/002292

§ 371 Date: Mar. 29, 2016

(30) Foreign Application Priority Data
Oct. 4, 2013 (JP) 2013-209168

(51) Int. Cl. G09G 5/00; G06F 3/0488; B60K 35/00; G06F 3/041

(52) U.S. Cl. CPC G09G 5/006; G06F 3/0412; G06F 3/0488; B60K 35/00; G09G 2380/10; G09G 2320/08; G09G 2320/10; B60K 2350/1004; B60K 2350/1076; B60K 2350/906; B60K 2350/901

(57) ABSTRACT

A display controller of an information terminal that controls a display mode of an operation screen of the information terminal used in a vehicle includes: an attribute value computing unit that computes an attribute value of an operation required for completing all operations of the relevant operation components for each operation component constituting the operation screen; and a display mode control unit that changes the display mode of the corresponding operation component when the computed attribute value is greater than an upper limit value allowed for the operation of the information terminal in a state where a vehicle condition transitions from a stop state.

### BACKGROUND OF THE INVENTION

1. Field of the Invention

The present invention relates to a display controller of an information terminal and a display control method of an information terminal.

2. Description of Related Art

An in-vehicle information terminal such as a navigation system has various functions such as searching for a route to a destination, searching for a point of interest (POI), and playing music. In order to provide a function desired by a user, an operation screen on which an input operation is performed by the user is displayed on a display screen of the in-vehicle information terminal.

The operation of the in-vehicle information terminal must not have a negative effect on a vehicle driving operation, and it is also not preferable that the operation of the in-vehicle information terminal greatly inconveniences a user. Accordingly, in order to achieve suitable compatibility of the prevention of a negative effect of the operation of an application on a driving operation and convenience, an application management device has been proposed which regulates execution of an application on the basis of a vehicle condition (for example, see Japanese Patent Application Publication No. 2012-111317 (JP 2012-111317 A)). When a vehicle is in a running state, this device operates an examined application in a regulation mode in which the function thereof is partially regulated and forcibly regulates input and output of a non-examined application.

In the device described in JP 2012-111317 A, convenience is improved by executing the examined applications in a regulation mode in which the function thereof is partially regulated even in a state where the vehicle is running. However, since the examined applications are switched to the regulation mode without exception at the time of . transitioning to the running state, convenience may be degraded depending on the timings of operating the applications. That is, there is room for improvement in the suitable compatibility of the prevention of a negative effect of the operation of an application on a vehicle driving operation and convenience in use of the application. This problem is not limited to in-vehicle information terminals having the above-mentioned configuration but is common in mobile information terminals such as smart phones or other mobile phones used in a vehicle.

### SUMMARY OF THE INVENTION

The invention provides a display controller of an information terminal and a display control method of an information terminal which can maintain convenience in use of an information terminal at a high level while preventing an operation of the information terminal from having an effect on a vehicle driving operation.

According to a first aspect of the invention, there is provided a display controller of an information terminal that controls a display mode of an operation screen of an information terminal used in a vehicle. The display controller of an information terminal includes: an attribute value computing unit that computes an attribute value of an operation required for completing all operations of the relevant operation components for each operation component constituting the operation screen; and a display mode control unit that changes the display made of the corresponding operation component when the computed attribute value is greater than an upper limit value allowed for the operation of the information terminal in a state where a vehicle condition transitions from a stop state.

According to a second aspect of the invention, there is provided a display control method of an information terminal that controls a display mode of an operation screen of an information terminal used in a vehicle. The display control method of an information terminal includes: causing a display control unit, which controls the display mode of the operation screen, to compute an attribute value of an operation required for completing all operations of the relevant operation components for each operation component constituting the operation screen; and changing the display mode of the corresponding operation component when the computed attribute value is greater than an upper limit value allowed for the operation of the information terminal in a state where a vehicle condition transitions from a stop state.

According to these aspects, when the attribute value computed for each operation component is greater than the allowed upper limit value, the display mode of the corresponding operation component is changed. That is, without changing the display mode without exception when the vehicle condition transitions from a stop state, the display mode of the corresponding operation component is dynamically changed each time depending on the computed attribute value. As a result, it is possible to maintain the convenience in use of the information terminal at a high level while preventing the operation of the information terminal from having an effect on a vehicle driving operation depending on the setting of the allowed upper limit value.

In the aspect, the attribute value computing unit may acquire a component attribute value correlated with each operation component and screen layer information indicating a link relationship between screen layers and may compute the attribute value by accumulating the component attribute values of the operation components that are operated until reaching the operation component of which the operation is completed on the basis of the screen layer information.

According to this configurations, since the attribute value is computed by accumulating the component attribute values of all the operated components, it is possible to obtain the attribute value corresponding to each operation step after transitioning from a stop state or while transitioning from the stop state.

In the aspect, the attribute value computing unit may compute the time required for completing the operations of all the operation components. According to this configuration, since the time required for completing the operation is computed in order to determine the display mode of the corresponding operation component, it is possible to weight complication of an operation, difficulty in recognition of a component, and the like depending on the time.

In the aspect, the component attribute value correlated with each operation component may include the time required for recognizing the corresponding operation component in the operation screen and the time required for operating the corresponding operation component. According to this configuration, the attribute value includes a recognition time for the components displayed on the screen and an operation time for operating the operation components. Accordingly, even with the same operation frequency, a screen including a large number of components and a screen having a small number of components can be weighted depending on the tithe.

In the aspect, the attribute value computing unit may compute the total operation frequency until all the relevant operations are completed as the attribute value for each operation component. According to this configuration, since the operation frequency required for completing all the relevant operations is computed as a completion attribute value, it is possible to reduce a computational load.

In the aspect, the display controller of an information terminal may further include a function limiting unit that deactivates the operation function of the operation component of which the display mode is changed by the display mode control unit. According to this configuration, since the operation function of the operation component of which the display mode is changed is deactivated, at least the operation of the corresponding operation component does not have an effect on the vehicle driving operation.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram illustrating a configuration of an in-vehicle information terminal in a first embodiment of a display controller of an information terminal and a display control method of an information terminal according to the invention;

FIG. 2 is a diagram schematically illustrating a data structure of screen construction data stored in the in-vehicle information terminal;

FIG. 3 is a diagram schematically illustrating screen flow data stored in the in-vehicle information terminal;

FIG. 4 is a flowchart illustrating a control sequence of a display control in the in-vehicle information terminal;

FIG. 5A is a diagram illustrating a display mode of a screen and illustrating a state where the display mode of a selected operation component is changed;

FIGS. 5B to 5D are diagrams illustrating a display mode of a screen and illustrating a state where the display mode of a selected operation component is not changed;

FIG. 6 is a flowchart illustrating a control sequence of a display control in an in-vehicle information terminal in a second embodiment of a display controller and a display control method of an information terminal according to the invention; and

FIG. 7 is a block diagram illustrating a configuration of an in-vehicle information terminal in a, third embodiment of a display controller and a display control method of an information terminal according to the invention.

### DETAILED DESCRIPTION OF EMBODIMENTS

### First Embodiment

Hereinafter, a first embodiment of a display controller and a display control method of an information terminal will be described.

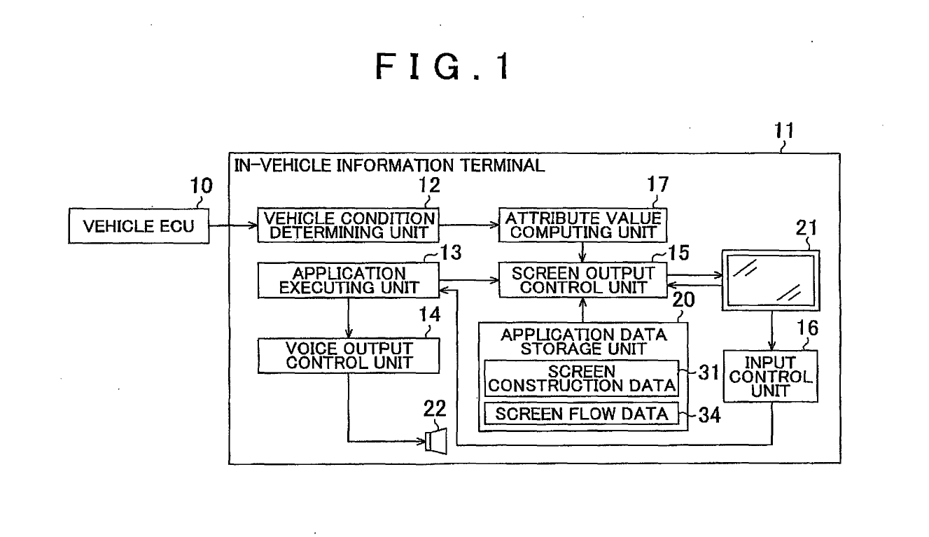

As illustrated in FIG. 1, an in-vehicle information terminal 11 as an information terminal in this embodiment is a. navigation system and has a function of specifying a vehicle position using a global positioning system (GPS) or the like, a function of searching for a route to a destination on the basis of the specified vehicle position and map data, and a function of searching for a point of interest (POI).

A vehicle on which the in-vehicle information terminal 11 is mounted is provided with a vehicle ECU 10 that acquires a vehicle condition. In this embodiment, a vehicle speed is acquired as the vehicle condition from a vehicle speed sensor disposed in the vehicle. The vehicle ECU 10 outputs the vehicle speed acquired from the vehicle speed sensor to the in-vehicle information terminal 11 via an in-vehicle network.

The in-vehicle information terminal 11 includes a vehicle condition determining unit 12. The vehicle condition determining unit 12 determines in which of a stop state and a running state the vehicle condition is on the basis of the vehicle speed output from the vehicle ECU 10. In this embodiment, it is determined that the vehicle condition is the running state when the vehicle speed is equal to or higher than a predetermined speed, and it is determined that the vehicle condition is the stop state when the vehicle speed is less than the predetermined speed.

The in-vehicle information terminal 11 includes an application executing unit 13 that executes an application. The application executing unit 13 executes applications on the basis of pre-installed application programs or application programs added later by a user. The application executing unit 13 controls a voice output control unit 14 disposed in the in-vehicle information terminal 11 so as to output a voice from a speaker 22 or controls a screen output control unit 15 as the display mode control unit, the function limiting unit, and the display control unit so as to display various screens on a display 21, depending on functions or settings of the applications.

The display 21 is a touch panel type display and a touch position touched with a user's finger is detected by an input control unit 16 disposed in the in-vehicle information terminal 11. The input control unit 16 outputs the detected touch position to the application executing unit 13 and the application executing unit 13 operates depending on the touch position.

The screen output control unit 15 reads screen construction data 31 and screen flow data 34 stored in an application data storage unit 20 on the basis of a command output from the application executing unit 13, generates screen display data, and outputs the data to the display 21.

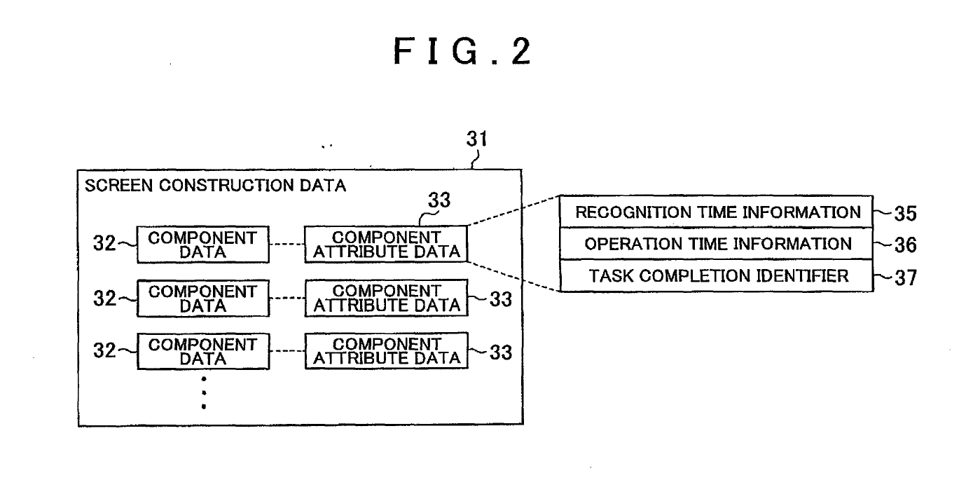

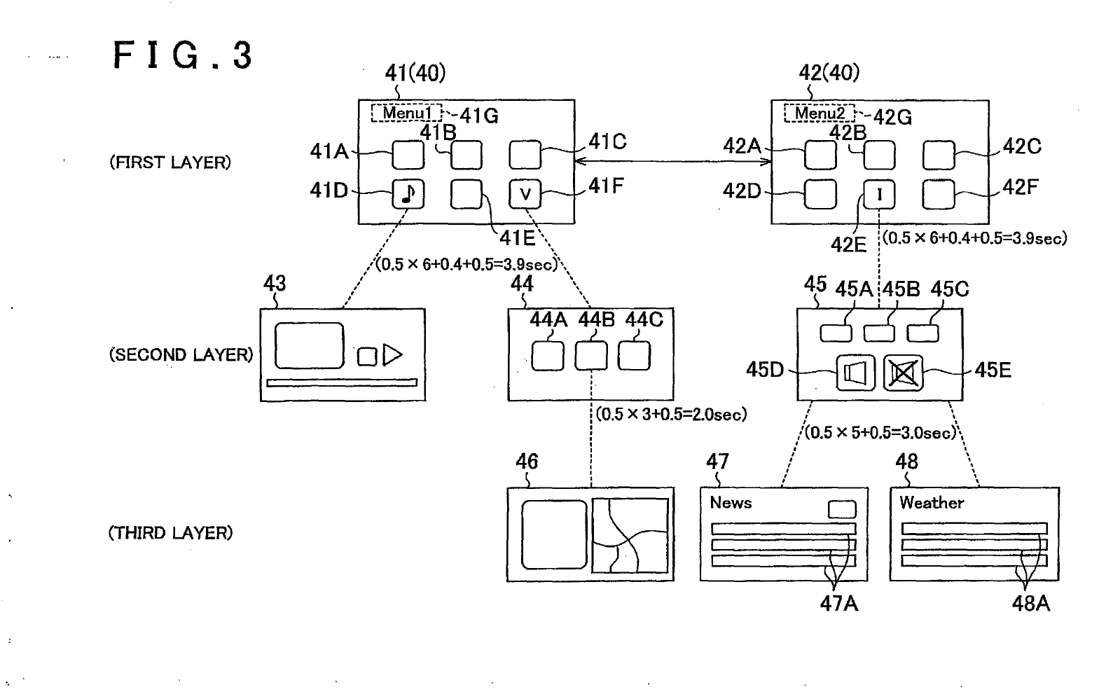

Data structures of the screen construction data 31 and the screen flow data 34 will be described below with reference to FIGS. 2 and 3. As illustrated in FIG. 2, the screen construction data 31 includes plural component data pieces 32. The “component” mentioned herein is a part combined into a screen and is a generic name of images such as icons, characters, illustrations, and photographs regardless of operability. The “operation component” is a component which can be operated out of the components and means a button or the like in the operation screen.

The component data 32 is image data itself displayed on the screen. The component data 32 is correlated with component attribute data 33. The component attribute data 33 includes recognition time information 35, operation time information 36, and a task completion identifier 37 which are set for each component.

The recognition time information 35 is set in advance and indicates the time required for allowing a user to recognize the function or the display details of one component in each operation screen. The operation time information 36 is also set in advance and indicates the time required for selectively operating one operation component in each operation screen.

The task completion identifier 37 is an identifier indicating whether the corresponding component is an operation component for completing a task required for completing all operations so as to provide a function desired by a user. Here, the “task” indicates a bundle of operations which are performed on an application and includes an operation for starting an application, an operation for changing the setting of an application, and the like. For example, the task completion identifier is set to “1” when the operation component corresponds to the final component of the task, and is set to “0” when the task is not completed by selectively operating the operation component.

As illustrated in FIG. 3, the screen flow data 34 is data indicating a link relationship between screens layered with the menu screen 40 as a vertex. As described above, in this embodiment, since the in-vehicle information terminal 11 has a configuration in which a user can add an application, plural menu screens 41, 42 are arranged in the same layer so as to cope with an increase in application. When the in-vehicle information terminal 11 is started, the first menu screen 41 is displayed on the display 21 and the second menu screen 42 on which icons different from the first menu screen 41 are displayed is displayed depending on the user's operation.

As illustrated in FIG. 1, the in-vehicle information terminal 11 is provided with an attribute value computing unit 17 constituting the display control unit. The attribute value computing unit 17 computes the total task time Ttsk indicating the time until the task is completed after the task is started for each operation component by accumulating the recognition time information 35 and the operation time information 36 before displaying a screen.

A technique of computing the total task time Ttsk will be described below with reference to FIG. 3. It is assumed that a “music playback” application for playing a music file stored in a hard disk thereof or the like, a “VICS” application for displaying information provided through a vehicle information and communication system (VICS: registered trademark), and a “news” application added by a user so as to provide information such as news acquired from the outside are installed in the in-vehicle information terminal 11 in advance. These applications are only examples and the pre-installed applications may vary depending on the in-vehicle information terminal 11. The number or combination of applications to be installed by a user varies depending on the in-vehicle information terminal 11.

In the example illustrated in FIG. 3, a button serving as an entrance for executing the “music playback” application is displayed on the first menu screen 41 as a first layer. As a sequence for executing the “music playback”, an execution button 41D of the first menu screen 41 only has to be selected. The task of “music playback” is completed by operating the execution button 41D. As a result, a task completion screen 43 of “music playback” as a second layer is displayed and music pieces stored in the hard disk or the like is played in a predetermined order.

For example, when the first menu screen 41 is displayed, the attribute value computing unit 17 computes the time required for operating the execution button 41D in the first menu screen 41 as the total task time Ttsk of “music playback”.

At this time, the attribute value computing unit 17 reads the component attribute data 33 correlated with the buttons 41A to 41F as the operation components and a title display section 41G which are displayed on the first menu screen 41 and adds the time obtained by adding the recognition time information 35 of the buttons 41A to 41F and the title display section 41G to the operation time information 36 of the execution button 41D for selecting the “music playback”. For example, when the recognition time information 35 of the respective buttons 41A to 41F. is “0.5 seconds”, the recognition time of the title display section 41G is “0.4 seconds”, and the operation time information 36 of the selection button 41F is “0.5 seconds”, the total task time Ttsk is “0.5 sec×6+0,4 sec+0.5 sec=3.9 sec”.

In the example illustrated in FIG. 3, the button serving as an entrance for displaying or changing setting of the “VICS” application is displayed as a selection button 41F on the first menu screen 4 L As the sequence for executing “VICS” or changing the setting thereof, the selection button 41F on the first menu screen 41 is first selected .to display a selection screen 44 of the second layer. The selection screen 44 is a screen for selecting modes such as “only highway”, “highway/general road”, and “non-display” through the operation of the selection buttons 44A to 44C. By selecting one of the selection buttons 44A to 44C, all tasks for displaying the VICS information or changing the setting thereof are completed. When the selection buttons 44A, 44B of “only highway” or “highway/general road” are selected in the selection screen 44, a screen 46 for displaying the VICS information as a third layer is output to the display 21.

For example, when the first menu screen 41 is displayed, the attribute value computing unit 17 computes the time required for completing the task in the operation transitioning from the first menu screen 41 to a screen of a lower layer as the total task time Ttsk for displaying the VICS information. As described above, the task time (3.9 sec) in the first menu screen 41 is computed. The. component attribute data 33 corresponding to the selection buttons 44A to 44C displayed on the selection screen 44 is read and the task time in the screen is computed. For example, when the recognition time information 35 for recognizing the respective buttons 44A to 44C is “0.5 sec” and the operation time information 36 set for the operation of selecting one of the buttons 44A to 44C is “0.5 sec”, the task time in the selection screen 44 is “0.5 sec×3+0.5 sec=2 sec”. Accordingly, the total task time Ttsk of the “VICS” application based on the first menu screen 41 is a value (3.9 sec+2.0 sec=5.9 sec) obtained by adding the times required for the respective screens 41 and 44.

In the example illustrated in FIG. 3, the “news” application is started from the second menu screen 42 as the first layer. As the sequence of starting the execution of the “news” application, a category selection button 42E such as “information” displayed on the second menu screen 42 is first operated to transition to an information selection screen 45. Selection buttons 45A to 45C for selecting fields of information displayed such as “news”, “weather”, and “traffic” and execution buttons 45D, 45E for selecting “vocal reading” and “no voice” are displayed on the information selection screen 45. In the information selection screen 45, the task is completed by selecting one of the selection buttons 45A to 45C and then selecting one of the execution buttons 45D, 45E. When the execution button 45D of “vocal reading” is operated, a voice of reading news or the like is output from a speaker 22. When the execution button 45E of “no voice” is operated, no voice is output. When the execution button 45D of “vocal reading” is operated, the task is completed at that time. However, when the execution button 45E of “no voice” is operated, the. task is completed by selectively operating buttons 47A, 48A indicating “topic” on screens 47, 48 displayed in the next time.

For example, when the second menu screen 42 is displayed, the attribute value computing unit 17 computes the task time (3.9 sec) of the second menu screen 42 and the task time (for example, 3.0 sec). of the information selection screen 45 as the second layer using the same method as described above and computes the total task time

Ttsk by adding the task times. When there is a possibility that the task will be further branched from the screen of the second layer, the total task time Ttsk is computed for each branched task. For example, when a task that is completed by selecting the execution button 45D and a task that is completed in the next screen 47, 48 by selecting the execution button 45E are present on the information selection screen 45, the total task times Ttsk of the tasks are computed, In this application, the total task time Ttsk for operating the execution button 45E of “no voice” is longer than the total task time Ttsk for operating the execution button 45D of “vocal reading”.

The attribute value computing unit 17 compares an operation-enabled time Topr in which the operation is allowed with the computed total task times Ttsk. The operation-enabled time Topr is the upper limit value of the time allowed for the operation of the in-vehicle information terminal 11 in a state where the vehicle condition transitions from the stop state. When the total task time Ttsk is equal to or less than the operation-enabled time Topr, the attribute value computing unit 17 outputs a command to display the operation components relevant to the task in a normal mode to the screen output control unit 15. As a result, the buttons and the like as the operation components are displayed in an active state in which they can be operated. On the other hand, when the total task time Ttsk is greater than the operation-enabled time Topr, the attribute value computing unit 17 outputs a command to tone down and display the operation components relevant to the task in an inactive state in which they are deactivated to the screen output control unit 15. The button in the inactive state cannot be operated and the user's operation of the application is limited. When a task in a screen of a layer lower than the screen serving as the reference is branched into plural parts as described above and only when the total task times Ttsk thereof are greater than the operation-enabled time Topr, the corresponding operation components are displayed in the inactive state. That is, when a task of which the total task time Ttsk is less than the operation-enabled time Topr is present among the plural tasks, the corresponding operation component is displayed in the active state.

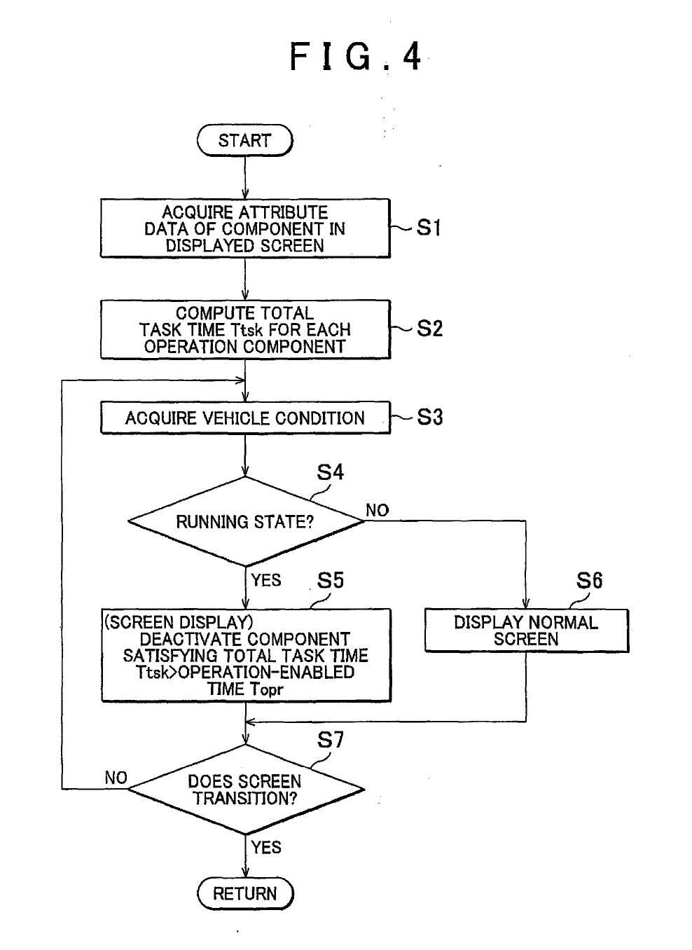

Operations particularly relevant to a display control of the in-vehicle information terminal 11 will be described below with reference to FIG. 4. First, when the in-vehicle information terminal 11 is started, the attribute value computing unit 17 reads the component attribute data 33 corresponding to the components displayed on the first menu screen 41 (step S1). The attribute value computing unit 17 computes the total task time Ttsk for each operation component displayed on the first menu screen 41 using the same technique as described above on the basis of the read component attribute data 33 (step S2). As described above, a button as an operation component cannot be said to be correlated with one application (task). For example, when a button is used to select a category, the button may be correlated with plural applications. In this case, the attribute value computing unit 17 computes the total task times Ttsk of all the tasks correlated with the operation component.

The vehicle condition determining unit 12 acquires the vehicle speed output from the vehicle ECU 10 as a vehicle condition (step S3), and determines whether the vehicle condition is a running state (step S4). When the vehicle condition determining unit 12 determines that the vehicle is not in the running state but is in the stop state (NO in step S4), the screen output control unit 15 reads the screen construction data 31 and displays the first menu screen 41 in the normal display mode on the display 21 (step S6). That is, in this screen, all the operation components are displayed in a state (active state) where the selection operation is enabled.

On the other band, when the vehicle condition determining unit 12 determined that the vehicle condition is the running state (YES in step S4), the first menu screen 41 is displayed in a mode in which the operation components of which the total task time Ttsk is greater than the operation-enabled time Topr are set to a selection-disabled state (inactive state) (step S5). When the screen is displayed in this way (steps S5, S6), the screen output control unit 15 determines whether to cause the screen to transition on the basis of the output from the input control unit 16 (step S7).

When the screen output control unit 15 determines that the screen does not transition (NO in step S7), the vehicle condition determining unit 12 acquires the vehicle condition in step S3 again and determines whether the vehicle condition is the running state again (step S4). When the stop state is continuously maintained, the screen display in which the operation components are set to the active state is maintained. When the vehicle condition transitions from the stop state to the running state, the total task time Ttsk correlated with the respective components is compared with the operation-enabled time, Topr, and an operation component of which the total task time Ttsk is greater than the operation-enabled time Topr is switched to a display in the inactive state. When the vehicle condition transitions from the running state to the stop state, a component displayed in the inactive state is switched to the active state.

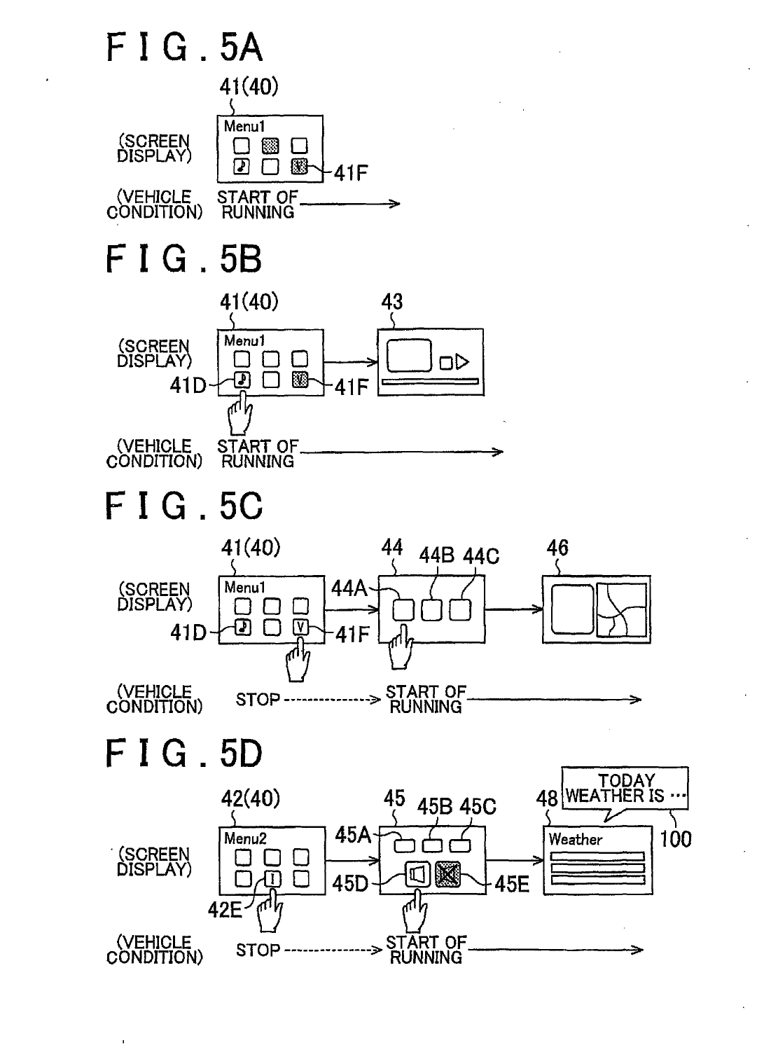

An operation example of a component and a transition example of a screen based on such a display control will be described below in more detail. As illustrated in FIG. 5A, when the vehicle starts running before the first menu screen 41 is displayed or while the first menu screen 41 is displayed and when the total task time Ttsk computed for the “VICS” application is greater than a predetermined operation-enabled time Topr, the selection button 41F of “VICS” is switched to the inactive state. As a result, the starting or the setting change of the “VICS” application is limited. In addition, when an operation component of a task of which the total task time Ttsk is greater than the operation-enabled time Topr is present, the operation component is switched to the inactive state. Regarding the operation components corresponding to a task of which the total task time Ttsk is equal to or less than the operation-enabled time Topr, the buttons corresponding to the application are displayed in the active state.

As illustrated in FIG. 5B, when the vehicle starts running before the first menu screen 41 is displayed or while the first menu screen 41 is displayed and, for example, when the total task time Ttsk of the “music playback” application is equal to or less than the operation-enabled time Topr, the execution button 41D displayed in the active state. That is, the “music playback” application can be executed even after the vehicle starts running.

On the other hand, when the screen is operated by a user and the screen output control unit 15 determines that the screen transitions (YES in step S1), the above-mentioned process is repeatedly performed on the basis of the transitioned screen again in step S1.

As illustrated in FIG. 5C, it is assumed that the vehicle starts running, for example, when the first menu screen 41 transitions to the selection screen 44 for selecting the display mode of the VICS information or while the selection screen 44 is displayed. At this time, the total task time Ttsk with the selection screen 44 as a start point is computed before the selection screen 44 is displayed in step S2. When the computed total task time Ttsk (2 sec) is shorter than the total task time Ttsk (5.9 sec) computed with the first menu screen 41 as a start point and the total task time Ttsk is equal to or less than the operation-enabled time Topr, the buttons 44A to 44C are displayed in the active state and one thereof can be operated. That is, the “VICS” application cannot be operated when the vehicle starts running while the first menu screen 41 is displayed, but the application can be operated after transitioning to the selection screen 44.

As illustrated in FIG. 5D, it is assumed that the vehicle starts running, for example, when the second menu screen 42 transitions to the information selection screen 45 or after the second menu screen 42 transitions to the information selection screen 45. At this time, in step S2, the total task time Ttsk is computed on the basis of the information selection screen 45 before the information selection screen 45 is displayed. When the total task time Ttsk of the task that is completed by operating the execution button 45D of “vocal reading” is equal to or less than the operation-enabled time Topr, the execution button 45D is displayed in the active state: When the execution button 45D of “vocal reading” is operated, information is read with a voice 100. When the execution button 45E of “no voice” is operated and the total task time Ttsk of the task that is completed in the next screen 47, 48 is greater than the operation-enabled time Topr, the execution button 45E is displayed in the inactive state. Even on a screen of a layer lower than the first layer, an operation component displayed in the active state and an operation component displayed in the inactive state are present depending on the timing of starting of the vehicle.

In this embodiment, since the total task time Ttsk is computed on the basis of the component attribute data 33 correlated with the corresponding operation component for each operation component in this way, it is possible to compute the total task time Ttsk even when the arrangement of the operation components is changed in the screen or between the screens by the user's operation. Since the control of the display mode is not performed on the entire screen, it is possible to allow at least the transitioning from the first menu screen 41 to the second menu screen 42. Accordingly, even when the number of operation components displayed on the menu screen 40 increases by allowing the user to add an application, the steps of displaying an operation component of which the operation is desired by the user can be performed even at the time of running of the vehicle.

As described above, the following advantages are obtained in the display controller and the display control method of an information terminal according to this embodiment. (1) When the total task time Ttsk computed for each operation component is greater than the operation-enabled time Topr which is the allowable upper limit value, the display mode of the corresponding operation component is changed. That is, without changing the display mode without exception when the vehicle condition transitions from the stop state, the display mode of the corresponding operation component is dynamically changed each time depending on the computed total task time Ttsk. As a result, it is possible to maintain the convenience in use of the in-vehicle information terminal 11 at a high level while preventing the operation of the in-vehicle information terminal 11 from having an effect on the vehicle driving operation depending on the setting of the operation-enabled time Topr.

(2) The total task time Ttsk is computed by accumulating the values of the component attribute data 33 of all the components operated until the task is completed. Accordingly, after the vehicle transitions from the stop state or while the vehicle transitions from the stop state, the total task time Ttsk corresponding to each operation step can be obtained.

(3) Since the total task time Ttsk is computed as the attribute value required for completing a task, it is possible to weight complication of an operation, non-easiness in recognition of a component, and the like depending on the time.

(4) The total task time Ttsk includes the recognition time required for recognizing the operation components of each screen and the operation time required for operating the operation components. That is, even in the tasks having the same operation frequency until a task is completed, the recognition time or the operation time as the attribute value can be set to be long for a screen in which it is difficult to recognize the components thereof or a screen in which the operation is complicated, and the recognition time or the operation time as the attribute value can be set to be short for a screen in which it is easy to recognize the components thereof or a screen in which the operation is easy.

(5) Since the operation function of an operation component of which the display mode is changed to the inactive state by the screen output control unit 15 is set to be inactive, at least the operation of the corresponding operation component does not have an effect on the vehicle driving operation.

### Second Embodiment

A second embodiment of a display controller and a display control method of an information terminal will be described below with a focus put on a difference from the first embodiment. The display controller according to this embodiment has the same basic configuration as the first embodiment, substantially the same elements as in the first embodiment in the drawings will be referenced by the same reference numerals and description thereof will not be repeated.

The component attribute data 33 in this embodiment does not include the recognition time information 35 and the operation time information 36 and includes the task completion identifier 37 and operation frequency information. The operation frequency information indicates the operation frequency of the corresponding component. For example, the operation frequency information is set to “1” for an operation component such as a selection button and is set to “0” for a component other than an operation component. The operation frequency information is configured to identify types of buttons, for example, when plural types of operation components are present in one screen such as when one of plural buttons is selected and an “enter” button is pressed. The attribute value computing unit 17 computes the total operation frequency Ntsk by accumulating the operation frequency until a task is completed on the basis of the component attribute data 33 and the screen flow data 34. The total operation frequency Ntsk indicates the operation frequency until a task is completed. The attribute value computing unit 17 compares the total operation frequency Ntsk with an operation-enabled frequency Nopr which is the upper limit allowed for the operation of the in-vehicle information terminal 11 in a state where the vehicle condition transitions from the stop state, and displays a component of which the total operation frequency Ntsk is greater than the operation-enabled frequency Nopr in the inactive state.

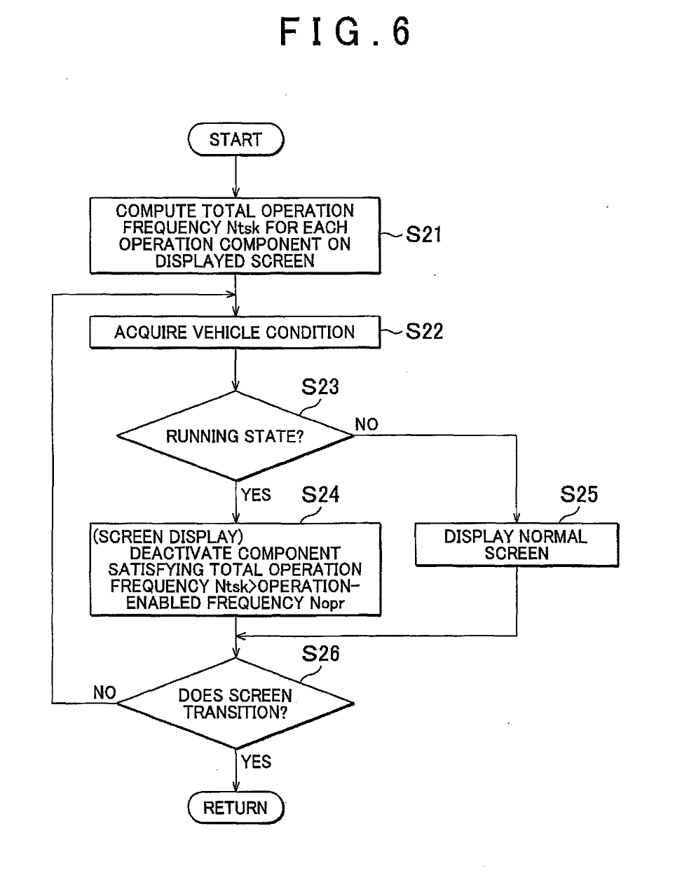

Operations particularly relevant to the display control of the in-vehicle information terminal 11 in this embodiment will be described below with reference to FIG 6. In this embodiment, the attribute value computing unit 17 computes the total operation frequency Ntsk for each operation component on a displayed screen on the basis of the screen flow data 34 and the component attribute data 33 (step S21).

The vehicle condition determining unit 12 acquires the vehicle condition similarly to the first embodiment (step S22) and determines whether the vehicle condition is the running state (step S23). When the vehicle condition determining unit 12 determines that the vehicle is in the stop state (NO in step S23), the screen output control unit 15 displays a normal screen in which all the components are displayed in the active state (step S25).

On the other hand, when the vehicle condition determining unit 12 determines that the vehicle condition is the running state (YES in step S23), the screen output control unit 15 displays a screen in which an operation component of which the total operation frequency Ntsk is greater than the operation-enabled frequency Nopr is displayed in the inactive state (step S24).

When the screen transitions (YES in step S26), the total operation frequency Ntsk is computed again before the screen is displayed in step S21. When the screen does not transition (NO in step S26), the display mode is switched depending on the vehicle condition again in step S22.

As described above, the following advantages are obtained in the display controller and the display control method according to this embodiment. (6) When the total operation frequency Ntsk computed for each operation component is greater than the operation-enabled frequency Nopr which is the allowable upper limit value, the display mode of the corresponding operation component is changed. That is, without changing the display mode without exception when the vehicle condition transitions from the stop state, the display mode of the corresponding operation component is dynamically changed each time depending on the computed total operation frequency Ntsk. As a result, it is possible to maintain the convenience in use of the in-vehicle information terminal 11 at a high level while preventing the operation of the in-vehicle information terminal 11 from having an effect on the .vehicle driving operation depending on the setting of the operation-enabled frequency Nopr.

(7) The total operation. frequency Ntsk is computed by accumulating the operation frequency information included in the component attribute data 33 of all the components operated until the task is completed. Accordingly, after the vehicle transitions from the stop state or while the vehicle transitions from the stop state, the total operation frequency Ntsk corresponding to each operation step can be obtained.

(8) Since the total operation frequency Ntsk until all the relevant operations are completed is computed as the attribute value required for completing a task, it is possible to reduce the computational load of the in-vehicle information terminal.

### Third Embodiment

A third embodiment of a display controller and a display control method of an information terminal will be described below with a focus put on a difference from the first embodiment. The display controller according to this embodiment has the same basic configuration as the first embodiment, substantially the same elements as in the first embodiment in the drawings will, be referenced by the same reference numerals and description thereof will not be repeated.

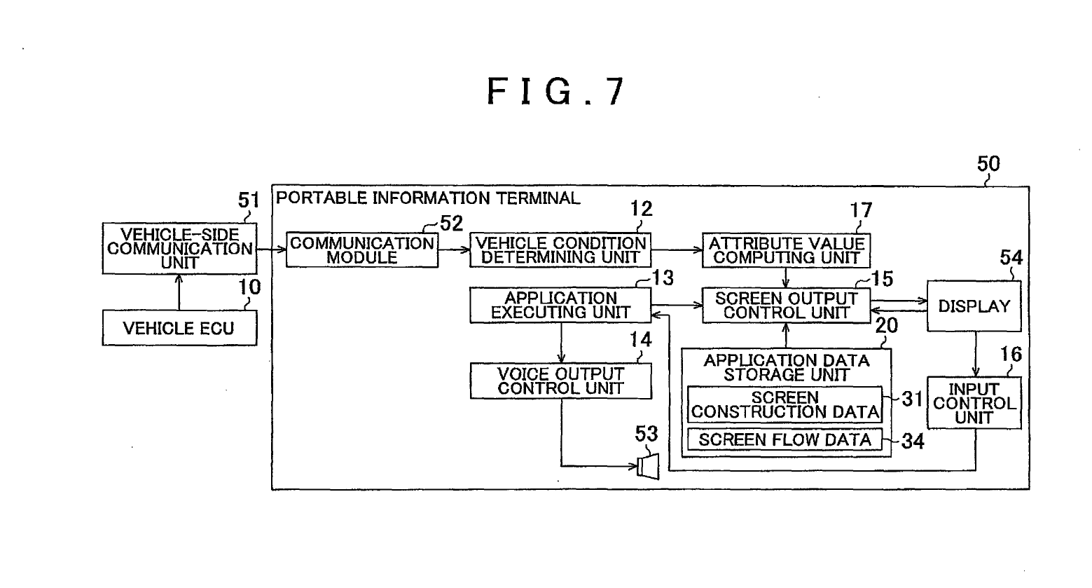

As illustrated in FIG. 7, an information terminal according to this embodiment is a portable information terminal 50 such as a smart phone carried into a vehicle. The portable information terminal 50 includes a communication module 52 that can communicate with a vehicle side. The communication module 52 acquires the vehicle condition transmitted from the vehicle ECU 10 via a vehicle-side communication unit 51 and outputs the acquired vehicle condition to the vehicle condition determining unit 12. The portable information terminal 50 has the same configuration as the configuration for performing the display control of the in-vehicle information terminal 11 in the above-mentioned embodiments, except for the communication module 52, a dedicated speaker 53, and a display 54. In this embodiment, the display 54 of the portable information terminal 50 is a touch panel type display.

The operations of the portable information terminal 50 are basically the same as the operations of the in-vehicle information terminal 11 in the first embodiment, but acquires the vehicle speed as the vehicle condition from the vehicle ECU 10 via the communication module 52.

Therefore, similarly to the, first embodiment, the above-mentioned advantages of (1) to (5) are obtained in the display controller and the display control method according to this embodiment.

### Other Embodiments

The above-mentioned embodiments may be embodied as follows.

In the above-mentioned embodiments, an operation component can be operated on the screen of the first layer, but the operation component can be set to the inactive state on a screen of a layer lower than the first layer. In addition, for example, when the vehicle condition is the stop state in a state where the screen of the first layer is displayed and an operation component therein is operated, the display mode of the operation component may be controlled so as to enable the operation thereof until the task is completed.

The total task time Ttsk is computed as the attribute value relevant to the operation until the task is completed in the first embodiment, and the total operation frequency Ntsk is computed as the attribute value in the second embodiment, but another parameter may be computed. For example, an achievement rate (%) to the total task time may be computed and compared with an upper limit value (%) thereof.

In the second embodiment, the component attribute data 33 includes the . operation frequency information, but the screen flow data 34 may be correlated with the operation frequency information on the respective screens. In the third embodiment, the portable information terminal 50 includes the communication module 52 for acquiring the vehicle condition. In addition, when the portable information terminal 50 includes a module capable of detecting the vehicle speed such as an acceleration sensor, the vehicle condition may be determined without communicating with the vehicle ECU 10.

After the vehicle transitions from the stop state, the display mode may be set depending on the magnitude of the vehicle speed. For example, the operation-enabled time Topr and the operation-enabled frequency Nopr may be set to be smaller at the time of running at a high speed than those at the time of running at a low speed. At the time of running at a high speed, the total task time Ttsk may be set to be large by multiplying the total task time Ttsk by a coefficient varying with the vehicle speed.

In the above-mentioned embodiments, when a task is branched into plural parts in a screen of a layer lower than a reference screen and only when all the total task times Ttsk thereof are greater than the operation-enabled time Topr, the corresponding operation components are displayed in the inactive state. In addition, when a task of which the total task time Ttsk is greater than the operation-enabled time Topr is present among the tasks branched in the lower layer, the corresponding operation components may be set to the inactive state.

In the above mentioned embodiments, the total task time Ttsk is computed each time before displaying a screen, but the total task time Ttsk of a task in which the arrangement of the operation component as an entrance such as a pre-installed application is not changed may not be computed each time but the once-computed total task time Ttsk may be maintained. According to this method, it is possible to reduce the computational load of the in-vehicle information terminal 11 or the portable information terminal 50.

The above-mentioned embodiments describe an example where an application is installed in the in-vehicle information terminal 11 or the portable information terminal 50, but an application that can be operated by the in-vehicle information terminal 11 or the portable information terminal 50 may be an application stored in the server via an external network.

In the above-mentioned embodiments, a vehicle speed is acquired as the vehicle condition, but other information may be acquired. For example, information on an ON/OFF state or a degree of operation of an accelerator pedal or an ON/OFF state of a brake pedal or a parking brake may be acquired and it may be determined on the basis of the acquired information whether the vehicle transitions from the stop state. Alternatively, it may be determined on the basis of an engine rotation speed whether the vehicle transitions from the stop state. Alternatively, it may be determined on the basis of plural information pieces indicating the vehicle state whether the vehicle transitions from the stop state.

In the above-mentioned embodiments, when the total task time Ttsk or the total operation frequency Ntsk is greater than the operation-enabled time Topr or the operation-enabled frequency Nopr as the upper limit value, the corresponding operation components are set to the inactive state in which the operation of the operation components is disabled. When the total task time or the total operation frequency Ntsk is greater than the upper limit value, only the display mode of the operation component may be changed, for example, so as to tone down or flicker the operation component.

In the above-mentioned embodiments, the total task time Ttsk and the total operation frequency Ntsk are computed only for a task transitioning from a reference screen to a screen of a lower layer, but the total task time Ttsk and the total operation frequency Ntsk may be computed for a task transitioning to a screen of a higher layer. For example, the total task time Ttsk and the total operation frequency Ntsk of a “return” button may be computed with the transitioning from the “return” button to a button which is a task entrance as a reverse task.

In the above-mentioned embodiments, the information terminal having a touch panel display 21 or 54 has been used as the information terminal, but a terminal other than such a type of information terminal may be used. For example, the invention may be applied to an information terminal such a type of display in which operation components displayed on a screen are operated with a cursor key or the like.

1. A display controller of an information terminal that controls a display mode of an operation screen of the information terminal used in a vehicle, comprising:
an attribute value computing unit that gets component attribute data including a recognition time information and a operation time information corresponding to operation components for each operation component and computes an total task time of an operation required for completing all operations of the relevant operation components by accumulating the recognition time information and the operation time information for each operation component constituting the operation screen based on a link relationship of the operation component, the recognition time being a time required for allowing a user to recognize the operation component in the operation screen, the operation time being a time required for operating the operation component; and
a display mode control unit that changes the display mode of the corresponding operation component when the computed total task time is greater than an upper limit value allowed for the operation of the information terminal in a state where a vehicle condition transitions from a stop state.

2. The display controller of the information terminal according to claim 1, wherein
the attribute value computing unit computes, when the task is branched in the operation screen of lower layer of the link relationship for the operation component, the total task time for each branched task, and
the display mode control unit unchanges, when one of the total task time for each branched task is equal to or lower than a upper limit value, the display mode of the corresponding operation component in the operation screen of higher layer.

3. The display controller of the information terminal according to claim 1, wherein
the attribute value computing unit computes, when the task is branched in the operation screen of lower layer of the link relationship for the operation component, the total task time for each branched task, and
the display mode control unit changes, when one of the total task time for each branched task is greater than a upper limit value, the display mode of the corresponding operation component in the operation screen of higher layer.

4. The display controller of the information terminal according to claim 1, wherein
some of the operation component is changed a arrangement in the operation screen or between layers of the operation screen and other operation component is unchanged the arrangement,
the attribute value computing unit computes the total task time at each time before displaying the operation screen for the operation component that is changed the arrangement and uses the total task time that is previously computed.

5. The display controller of the information terminal according to claim 1, wherein
the attribute value computing unit computes the total operation frequency until all the relevant operations are completed as the attribute value for each operation component.

6. (canceled)

7. A display control method of an information terminal that controls a display mode of an operation screen of the information terminal used in a vehicle, comprising:
getting by an attribute value computing unit, component attribute data including a recognition time information and a operation time information corresponding to operation components for each operation component and computing an total task time of an operation required for completing all operations of the relevant operation components by accumulating the recognition time information and the operation time information for each operation component constituting the operation screen based on a link relationship of the operation component, the recognition time being a time required for allowing a user to recognize the operation component in the operation screen, the operation time being a time required for operating the operation component; and
changing, by display mode control unit, the display mode of the corresponding operation component when the computed total task time is greater than an upper limit value allowed for the operation of the information terminal in a state where a vehicle condition transitions from a stop state.
